(19) United States
(12) Patent Application Publication
(10) Pub. No.: US 2014/0268321 A1
(43) Pub. Date: Sep. 18, 2014

(54) DEVICE FOR IMAGING ELECTRON MICROSCOPE ENVIRONMENTAL SAMPLE SUPPORTS IN A MICROFLUIDIC OR ELECTROCHEMICAL CHAMBER WITH AN OPTICAL MICROSCOPE

(71) Applicant: PROTOCHIPS, INC., Raleigh, NC (US)

(72) Inventors: John DAMIANO, JR., Apex, NC (US); David NACKASHI, Raleigh, NC (US); Daniel Stephen GARDINER, Wake Forest, NC (US); Franklin Stampley WALDEN, II, Raleigh, NC (US); William Bradford CARPENTER, Raleigh, NC (US); Madeline DUKES, Cross Hill, SC (US); Steven BUDD, Durham, NC (US)

(73) Assignee: PROTOCHIPS, INC., Raleigh, NC (US)

(21) Appl. No.: 14/207,905

(22) Filed: Mar. 13, 2014

Related U.S. Application Data
(60) Provisional application No. 61/779,201, filed on Mar. 13, 2013.

(51) Int. Cl. G02B 21/26; G01N 1/00

(52) U.S. Cl. CPC G02B 21/26; G01N 1/00
USPC 359/391; 356/244

(57) ABSTRACT

A sample holder for optical microscopy that incorporates sample holders typically used in electron microscopy to maximize the correlation between optical and electron microscopy images and data.

### FIELD

The present invention relates to a sample holder for optical microscopy and methods for using same.

### BACKGROUND

The present inventors previously described sample holders for electron microscopy, methods for introducing liquids or gases to the sample holder, and uses of the electron microscopy sample holder in U.S. patent application Ser. No. 13/813,818, filed on Feb. 1, 2013 and entitled “Electron Microscope Sample Holder for Forming a Gas or Liquid Cell with Two Semiconductor Devices,” which is hereby incorporated by reference herein in its entirety. Unfortunately, an electron microscopy sample holder cannot be readily used for optical microscopy. Moreover, to the best of the inventors knowledge, no one has attempted to provide a system whereby a sample can be imaged in both an electron microscope and an optical microscope with the minimization of artifacts due to variations in the electron microscope and optical microscope sample holders.

Accordingly, there is a need in the art for a sample holder for optical microscopy, methods for introducing liquids or gases to the sample holder, and uses of the sample holder for optical microscopy whereby a sample that can be imaged in an electron microscope can be imaged in an optical microscope and variations in the respective sample holders are minimized or eliminated.

### SUMMARY

The present invention relates generally to a sample holder for optical microscopy, specifically a sample holder that incorporates electron microscopy sample devices therein.

In one aspect, a sample holder for an optical microscope, said sample holder comprising:

(a) an optical microscope compatible base;
(b) a chamber comprising a chamber body and a chamber lid, wherein the chamber can accommodate liquids or gases, can be electrically biased, or both, and wherein the chamber can accommodate at least two sample support devices; and
(c) a port interface.

In another aspect, a method of imaging a sample in a liquid and/or gaseous environment using an optical microscope, said method comprising:

inserting a sample in the chamber of the sample holder, wherein the sample holder comprises (a) an optical microscope compatible base; (b) a chamber comprising a chamber body and a chamber lid, wherein the chamber can accommodate liquids or gases, can be electrically biased, or both, and wherein the chamber can accommodate at least two sample support devices; and(c) a port interface, wherein the optical microscope compatible base comprises said chamber,
positioning the optical microscope compatible base comprising the chamber and sample on an optical microscope stage,
introducing a liquid and/or gas to the sample in the chamber,
optionally applying and/or measuring thermal or electrical stimuli to the chamber and sample, and
imaging the sample using the optical microscope,
wherein the chamber body comprises at least one pocket having a pocket bottom and pocket walls for the positioning of two sample support devices therein.

Other aspects, features and embodiments of the invention will be more fully apparent from the ensuing disclosure and appended claims.

### BRIEF DESCRIPTION OF THE FIGURES

FIG. 1A is a plan view of embodiment of a sample holder for optical microscopy.

FIG. 1B is a exploded view of the microfluidic or electrochemical chamber of the sample holder of FIG. 1A.

FIG. 2 illustrates a top, bottom and cross-sectional view of a window device of the prior art.

FIG. 3 illustrates a top, bottom and three cross-sectional views of an electrical biasing device of the prior art.

FIG. 4 illustrates a top, bottom and three cross-sectional views of a heating device of the prior art.

FIG. 5 illustrates a cross-sectional view of a microfluidic or electrochemical chamber.

FIG. 6 illustrates a top view of the sample holder including the input and output ports in the pockets.

FIG. 7 illustrates a plan view of the sample holder of the device including the placement of the printed circuit board.

FIG. 8 illustrates a top view of the apparatus of FIG. 1A.

FIG. 9 illustrates a cross-section view of the apparatus of FIG. 8.

FIG. 10 illustrates a side view and a cross-sectional view of the apparatus of FIG. 1A.

### DETAILED DESCRIPTION

The present invention relates generally to a sample holder for optical microscopy, more specifically to a sample holder for optical microscopy that permits the use of sample holders typically used in electron microscopy to maximize the correlation between optical and electron microscopy images and data.

Advantageously, the optical microscopy sample holder and sample holder interface described herein are compatible with and may be interfaced with the electron microscopy semiconductor sample support devices disclosed in International Patent Application No. PCT/US08/63200, filed on May 9, 2008, which is incorporated herein by reference in its entirety. In other words, the presently disclosed optical microscopy sample holder can use the same semiconductor sample support devices, which allows for substantial correlation between optical and electron microscope images and data. It should be appreciated by one skilled in the art that alternative sample support devices may be interfaced with the sample holder described herein.

As defined herein, a “membrane region” on the semiconductor sample support device corresponds to unsupported material comprising, consisting of, or consisting essentially of carbon, silicon nitride, SiC or other thin films generally 1 micron or less having a low tensile stress (<500 MPa), and providing a region at least partially electron transparent region for supporting the at least one sample. The membrane region may include holes or be hole-free. The membrane region may be comprised of a single material or a layer of more than one material and may be either uniformly flat or contain regions with varying thicknesses.

As defined herein, “semiconductor” means a semiconductor material, such as silicon, that is intermediate in electrical conductivity between conductors and insulators.

As defined herein, a “device” or “sample support device” means a structure used to either contain liquids or gases around a sample and includes, but is not limited to, a window device, an electrical device and a heating device.

As defined herein, a “cell” corresponds to a region defined by two substantially parallel positioned devices, wherein at least one liquid or gas can be flowed or trapped between the two substantially parallel positioned devices. A sample can be positioned within the cell for imaging purposes.

As defined herein, “sample” or “specimen” means the object being studied in the optical microscope, for example in the cell having a region of liquid or gas as described herein.

As defined herein, a “pocket” corresponds to a space in a sample cell holder that defines the vertical walls of the cell, into which the two substantially parallel devices are positioned to form the cell.

As defined herein, “contact points” correspond to protrusions from the walls of the pocket that are engineered to align the devices when positioned in the pocket.

As defined herein, “frame” means a rigid region around the perimeter of a device that is used to provide mechanical support to the entire device structure. Preferred embodiments include a silicon frame selectively etched using KOH, a silicon frame selectively etched using reactive ion etching (RIE), a silicon frame selectively etched using deep reactive ion etching (DRIE), or a silicon frame released from an silicon-on-insulator (SOI) wafer.

As defined herein, a “light source” corresponds to any means that emit visible or ultraviolet light in a range from about 10 nm to about 760 nm including, but not limited to, incandescent lamps, arc lamps and laser light sources.

The sample holder described herein provides mechanical support and a liquid or gaseous environment for one or more samples and/or semiconductor support devices and may also provide electrical contacts to the samples and/or semiconductor support devices. The sample holder 10 comprises: at least one microfluidic or electrochemical chamber 20, at least one sample support device, a microscope compatible base 22, and a port interface 24, as shown in FIG. 1A and 1B. In FIG. 1B, two sample support devices 26, 28 are shown, but it is contemplated that only one sample support device be used, e.g., sample support device 26.

Advantageously, the sample holder described herein can use sample support devices that are typically used in an electron microscope, allowing for a simple correlation between optical and electron microscope images and data. As defined herein, the “sample holder device” means a structure used to either contain liquids or gases around a sample and includes, but is not limited to, a window device, an electrical device and a heating device. Alternatively, the “sample holder device” can correspond to a structure that a sample can be positioned on for imaging including, but not limited to, a window device, an electrical device and a heating device.

As defined herein, “window device” corresponds to a device used to create a physical barrier on one boundary and the external environment of the optical microscope on the other and is generally a silicon nitride-based semiconductor micro-machined part, although other semiconductor materials are contemplated. For example, a typical window device comprises diced SiN and glass E-chips, which provides very vertical edges and simplified handling of E-chips as compared to round 3 mm grids used in the optical microscopy industry. A prior art window device is shown in FIG. 2. It should be appreciated by the person skilled in the art that the window device contemplated for use in the sample holder described herein is not limited to that shown in FIG. 2.

The window device in FIG. 2 comprises a thin membrane region 30, e.g., amorphous silicon nitride, that forms the window whereby imaging and analysis can be performed through the window. The window's “frame” is preferably single-crystal silicon. The frame 32 is formed by selectively etching a cavity in the single-crystal silicon substrate. A thin “spacer” layer can be formed around the membrane window (not shown). The thickness of this spacer layer can be precisely set, and, when a second device, e.g., a heating device or another window device, is stacked atop the window device, the thickness of the spacer sets the distance between the substantially parallel devices and hence the thickness of the gas or liquid layer between the devices. Preferred spacer thickness is in a range from about 0.1 μm to about 50 μm. Spacer materials contemplated herein include, but are not limited to, epoxy-based photoresists such as SU-8 (Microchem, Newton, Mass.), grown or deposited semiconductor layers, deposited or electroplated metal films and polyimide films such as the HD-4100 series of polymers (Hitachi Dupont MicroSystems LLC).

A schematic of a generic electrical biasing device is shown in FIG. 3. The electrical biasing device has electrodes 40 that run from the edge of the device to the center of a thin silicon nitride membrane. Samples can be placed on the silicon nitride membrane region 42 for inspection. Typically voltage or current is applied to the electrodes at the edge of the chip, and these signals travel to the membrane region and the sample. The “frame” portion of the device, surrounding the membrane, can be single-crystal silicon. The frame 44 can be formed by selectively etching a cavity in the single-crystal silicon substrate. Gold contact pads 48 are used to form the electrodes. The silicon nitride material is electrically insulating. A thin “spacer” layer 46 can be formed around the membrane window. The thickness of this layer can be precisely set, and, when a second device, e.g., a window device, is stacked atop the electrical device, the thickness of the spacer sets the distance between the substantially parallel devices and hence the thickness of the liquid layer between the devices. Preferred spacer thickness is in a range from about 0.1 μm to about 50 μm. For example, the spacer layer can be removed over the gold electrodes 48 at the edge of the electrical device where contacts are formed. The cut in the spacer layer forms a seal around the contact when the devices are stacked and prevents the liquid from reaching the contact point between the device and the sample holder. It should be appreciated that the electrical biasing device can be larger, smaller, or the same dimensions as the window device. Moreover, it should be appreciated by the person skilled in the art that the electrical biasing device contemplated for use in the sample holder described herein is not limited to that shown in FIG. 3.

A schematic of a generic heating device is shown in FIG. 4. Samples can be placed on the thin membrane region 50, which is formed from layers of a conductive ceramic material, e.g., silicon carbide. When electrical current is forced through the ceramic membrane, the membrane region heats, heating the sample. The “frame” portion of the device, surrounding the membrane, can be single-crystal silicon. The frame 52 can be formed by selectively etching a cavity in the single-crystal silicon substrate. Gold contact pads 54 can be used to form electrical contacts to the ceramic material. An electrically insulating layer of silicon dioxide 56 or equivalent thereof between the ceramic layers and the silicon substrate prevents current flow from the ceramic membrane to the substrate, so all current stays in the membrane. In the embodiment shown in FIG. 4, the gold contact pads extend to one side of the device. It should be appreciated that the heating device can be larger, smaller, or the same dimensions as the window device. Moreover, it should be appreciated by the person skilled in the art that the heating device contemplated for use in the sample holder described herein is not limited to that shown in FIG. 4.

The apparatus has at least one microfluidic or electrochemical chamber 100 that allows for fluid flow or static trapping of fluid across a sample in this chamber, as illustrated in FIG. 5. As introduced above, the chamber and viewing environment can be replicated in size, shape and materials by an in-situ electron microscope sample holder (i.e., U.S. patent application Ser. No. 13/813,818) to provide a comparable platform for imaging and data, and allows for sample preparation optimization prior to working in an electron microscope. The chamber 100 is formed by compressing two semiconductor sample support devices 102, 104 against O-rings 106 with a spacer 107 therebetween. The compressing force is applied to the chamber lid 108, and the normal force is presented by the chamber body 110. The sample (not shown) is located on the internal grid of the two semiconductor sample support devices 102, 104. FIG. 5 illustrates one example of the microfluidic or electrochemical chamber whereby one device is a window device, e.g., 104, and the other is an electrical biasing device, e.g., 102. Although not illustrated, it should be appreciated that other combinations are possible including window device-window device, and window device-heating device.

As shown in FIG. 6, which is a top expanded view of the microfluidic chamber of FIG. 1B, fluids or gases flow from at least one input port 120 into the chamber that is bounded by the 0-rings 124 and then egresses through an output port 122. The semiconductor sample support devices are shown as transparent for illustrative purposes only. When there is more than one input port, fluids or gases can be mixed in the chamber, and then exhaust through the output port.

The chamber body can have a cavity with a deep pocket 130 and a shallow pocket 132 when the size of the two devices are different from one another (e.g., in FIGS. 1, 5 and 7, one device, e.g., a window device, is smaller in length than the the other device, e.g., an electrical or thermal device). It should be appreciated that when the two devices have the same length and width that the chamber body can have one deep cavity for accommodating both devices. The deep pocket 130 has a bottom with a light source hole (see, e.g., FIG. 5) roughly centered in the pocket, and at least one o-ring or other sealing means can be placed around the hole (see, e.g., 106 in FIG. 5). The depth of the deep pocket 130 relative to the shallow pocket 132 plane is approximately the thickness of the device 134, e.g., a window device. The length and width of the deep pocket 130 is slightly larger than a device 134, as will be discussed at length hereinbelow. The length and width of the shallow pocket 132 is slightly larger than the device 136, e.g., an electrical or thermal device, as will be discussed hereinbelow. The shallow pocket 132 fully encloses the deep pocket 130. The depth of the shallow pocket 132 is approximately the thickness of the 136. With regards to the chamber lid (not shown in FIG. 7), a light source hole is included such that light can pass through the lid (see, e.g., FIG. 5), the devices, the sample, and the chamber body 138. An o-ring 140 or other sealing means ensures a liquid or gas-tight seal upon securing the chamber lid to the chamber body 138.

As introduced in U.S. patent application Ser. No. 13/813,818, the chamber advantageously has a pocket(s) (i.e., 130, 132 in FIG. 7) having contact points rather than straight edge walls so as to improve alignment of the devices therein as well as easier placement and extraction. Referring to FIGS. 1B, 5 and 7, the pocket having two contact points for each wall of the sample support device(s) can be seen. Having two contact points for each edge of the device reduces the likelihood that debris in the pocket can impact the device alignment. When the pocket accommodates two equally sized devices (e.g., for the liquid cell), the vertical contact points extend the full depth of the cavity, so the two chips see the same contact points and are therefore aligned to each other. It should be appreciated that the pocket can have at least one straight edge so long as at least one edge includes the aforementioned contact points. When the pocket accommodates two different sized devices (e.g., a window device with an electrical or a thermal device), there are different contact points for each edge of each device. It should be appreciated that the contact points can be tooled to be any shape (e.g., hemispherical, square, triangular, etc.) or size as readily determinable by the skilled artisan.

While the chamber and materials that interact with the fluid or sample may be identical to the sample holder of U.S. patent application Ser. No. 13/813,818, the support hardware such as the lid and mounting technique take advantage of the optical “ex-situ” environment (i.e., no vacuum). The chamber lid can be either transparent (e.g., glass or quartz) to ease in the loading of samples, or it can be opaque with a hole over the sample for viewing. Flat springs or clips can hold the viewing stack in place or screws and mounting hardware can be used.

Electrical current and voltage biasing can be applied to the sample support to create an electrochemical cell in the microfluidic chamber. Current can be supplied to the sample support device (e.g., 136 in FIG. 7) with a printed circuit board (PCB) (e.g., 142 in FIG. 7) in a manner introduced in U.S. patent application Ser. No. 14/079,223 filed on Nov. 13, 2013 in the name of David Nackashi et al. and entitled “A Method for Forming an Electrical Connection to a Sample Support in and Electron Microscope Holder,” which claims priority to U.S. Provisional Patent Application No. 61/727,367 filed on Nov. 16, 2012 and U.S. Provisional Patent Application No. 61/779,294 filed on Mar. 13, 2013, which are hereby incorporated by reference herein in their entirety. For example, referring to FIG. 7, during assembly of the holder, the “male” PCB end 144 is inserted into the “female” barrel of the microscope compatible base. The male end of the PCB 144 has individual contact points for connection to wires (not shown). The other end of the PCB has exposed conductive contact points 146 that contact with electrical contacts 148 on the sample support device 136 when the sample support device is loaded into the holder. The size and spacing of the contacts on the PCB and the sample support device are similar so that they are aligned when stacked in the holder. When the chamber lid is placed atop the chamber body and pressed/affixed down, i.e., normal to the contact plane, the chamber lid pushes the sample support device on to the PCB, forming electrical connection between the sample support device and the PCB. In one embodiment, the placement of the PCB is such that the electrical contacts are positioned at the bottom of the shallow pocket.

Advantageously, when the sample support devices are E-chip surface treated, precise particle selection from a heterogeneous mixture is provided and these particles can attach to the E-chip so a homogeneous class of cells or particles can be imaged with an optical microscope. Fluid flows across a sample with a definable flow rate and volume to more accurately approximate a cellular micro-environment. The liquid or gas flow across a sample in the microfluidic chamber can sustain living samples for long periods while they culture or change.

The apparatus can be approximately the size of a standard 96 well plate making it physically compatible with optical microscope stages. For example, the width can be in a range from about 60 mm to about 120 min, preferably about 80 mm to about 90 mm, and the length can be in a range from about 100 min to about 150 min, preferably about 120 mm to about 135 mm The shape allows the standard stage fixtures to securely hold the apparatus for imaging and x, y and z translation. In one embodiment, the corners of the apparatus are chamfered and/or include notches to make the device easy to remove from standard well-plate fixtures, as illustrated in FIG. 8, which is a top view of the apparatus of FIG. 1.

As shown in FIG. 9, which illustrates the cross-section of A-A′ in FIG. 8, the apparatus can have a thin profile which allows for imaging with typical inverted, upright, confocal or stereo microscopes. The sample location in the microfluidic chambers accounts for standard working distances of optical lenses. In practice, the light from the light source travels through the material of the chamber lid (or the hole), the membrane of a first device, the sample, the membrane of a second device, and the opening of the chamber body, to the lens.

As shown in FIG. 10, which illustrates a side view and a cross-sectional view of the apparatus of FIG. 1, bulkheads and external port interfaces are located above the standard stage fixtures to allow for input lines to the apparatus without interference with the stage fixture. The microfluidic chambers and sample viewing area is removed from the port housing 160 to allow light sources and lenses to get close to the sample. Internal plumbing and wiring can run from the port interface to the microfluidic chamber in a manner that does not disturb the natural use of the optical microscope. The port interface includes a port housing 160 and a port plate 162. The port plate 162 is the access point for external elements such as fluids, gases, and/or electrical bias to interact with the apparatus. The apparatus has unions and bulkheads to account for a variety of liquid or gas input lines that run into each microfluidic chamber 164 as well as electrical inputs for electrochemical applications. The port housing 160 encompasses an inert passage 166 for fluids to flow from external ports on the port plate 162 to the microfluidic chamber 164 to interact with the sample as well as wire routing. To each chamber the apparatus can allow for at least two liquid input ports to allow for the dynamic mixing of reagents (for applications such as toxicology, infection, mineralization, drug delivery, etc.) and/or dynamic alterations of the liquid environment (such as changing sample concentration, pH, etc.

The apparatus can be heated to help keep organic samples living for longer periods of time by attaching or integrating a heat source into the port housing or liquid lines. A constant temperature in the microfluidic chamber could be achieved with a PID feedback controller. Electronics would interact with the heat source and temperature feedback system through the port plate.

In addition to the apparatus, a method of imaging a sample in a liquid and/or gaseous environment using an optical microscope is described, said method comprising:

inserting a sample in a chamber, wherein an optical microscope compatible base comprises said chamber,
positioning the optical microscope compatible base comprising the chamber and sample on an optical microscope stage,
introducing a liquid and/or gas to the sample in the chamber,
optionally applying and/or measuring thermal or electrical stimuli to the chamber and sample, and imaging the sample using the optical microscope,
wherein the chamber comprises a chamber body and a chamber lid, wherein the chamber body comprises at least one pocket having a pocket bottom and pocket walls for the positioning of two sample support devices therein.

It should be appreciated that the two sample support devices may be the same as or different from one another and can comprise a device selected from the group consisting of a window device, a heating device, an electrical biasing device, and combinations thereof. Further, the optical microscope compatible base further comprises a port interface, internal lines, and electric wiring.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

We claim:

1. A sample holder for an optical microscope, said sample holder comprising:
(a) an optical microscope compatible base;
(b) a chamber comprising a chamber body and a chamber lid, wherein the chamber can accommodate liquids or gases, can be electrically biased, or both, and wherein the chamber can accommodate at least two sample support devices; and
(c) a port interface.

2. The sample holder of claim 1, wherein the chamber body and the chamber lid allow for passage of a light source through the sample holder.

3. The sample holder of claim 1, wherein the chamber body comprises at least one pocket having a pocket bottom and pocket walls for the positioning of the two sample support devices therein.

4. The sample holder of claim 1, wherein the chamber body comprises at least one component selected from the group consisting of:
(a) at least one electrical contact;
(b) at least one inlet supply line;
(c) at least one outlet supply line;
(d) at least one sealing means;
(e) securing means for securing the lid to the holder; and
(f) combinations of (a)-(e) thereof.

5. The sample holder of claim 1, wherein the chamber lid is transparent or opaque.

6. The sample holder of claim 4, wherein the sealing means of the chamber body are positioned at the pocket bottom in proximity to a light source hole.

7. The sample holder of claim 1, further comprising two sample support devices in the pocket of the chamber body.

8. The sample holder of claim 7, wherein the two sample support devices are aligned so that the light source passes through the sample holder having the sample support devices therein.

9. The sample holder of claim 7, wherein the two sample support devices have (a) substantially identical dimensions or (b) different widths, different lengths, or both.

10. The sample holder of claim 9, wherein the two sample support devices have different widths, different lengths, or both, and wherein the pocket comprises a deep pocket and a shallow pocket.

11. The sample holder of claim 10, wherein the sealing means of the chamber body are further positioned in the shallow pocket around the deep pocket.

12. The sample holder of claim 9, wherein the two sample support devices have different widths, different lengths, or both, and wherein the at least one electrical contact is positioned on the bottom of the shallow pocket.

13. The sample holder of claim 3, wherein the pocket walls include at least two protrusions for each straight edge of each sample support device.

14. The sample holder of claim 4, wherein the sample holder comprises a printed circuit board (PCB) having a first end and a second end, wherein the first end has at least one electrical contact and the second end is insertable into the optical microscope compatible base, wherein the at least one electrical contact of the first end of the PCB and the at least one electrical contact of the sample support device are in contact in the chamber body.

15. The sample holder of claim 1, wherein the chamber and the port interface are positioned such that light sources and lenses do not interfere with the port interface while permitting light to pass through the chamber.

16. The sample holder of claim 1, wherein internal plumbing and wiring run from the chamber to the port interface.

17. A method of imaging a sample in a liquid and/or gaseous environment using an optical microscope, said method comprising:
inserting a sample in the chamber of the sample holder, wherein the sample holder comprises (a) an optical microscope compatible base; (b) a chamber comprising a chamber body and a chamber lid, wherein the chamber can accommodate liquids or gases, can be electrically biased, or both, and wherein the chamber can accommodate at least two sample support devices; and (c) a port interface, and wherein the optical microscope compatible base comprises said chamber,
positioning the optical microscope compatible base comprising the chamber and sample on an optical microscope stage,
introducing a liquid and/or gas to the sample in the chamber,
optionally applying and/or measuring thermal or electrical stimuli to the chamber and sample, and imaging the sample using the optical microscope,
wherein the chamber body comprises at least one pocket having a pocket bottom and pocket walls for the positioning of two sample support devices therein.

18. The method of claim 17, wherein the two sample support devices may be the same as or different from one another and can comprise a device selected from the group consisting of a window device, a heating device, an electrical biasing device, and combinations thereof.

19. The method of claim 17, wherein the optical microscope compatible base further comprises a port interface, internal lines, and electric wiring, wherein the internal lines and electric wiring run from the port interface to the chamber.

20. The method of claim 19, wherein the chamber is removed from the port interface to account for light sources and lenses.
